(19) United States
(12) Patent Application Publication
(10) Pub. No.: US 2012/0028773 A1
(43) Pub. Date: Feb. 2, 2012

(54) Method For Repairing A Roller, And Roller

(75) Inventors: Graham MacFarlane, Neunkirchen-Seelscheid (DE); Thorsten Pfeil, Cologne (DE); Jürgen Deussen, Cologne (DE)

(73) Assignee: FELIX BOTTCHER GMBH & CO. KG, Cologne (DE)

(21) Appl. No.: 13/192,625

(22) Filed: Jul. 28, 2011

Related U.S. Application Data
(60) Provisional application No. 61/369,154, filed on Jul. 30, 2010.

(30) Foreign Application Priority Data
Jul. 28, 2010 (EP) 10171090.3

(51) Int. Cl. F16C 13/00; B23P 6/00

(52) U.S. Cl. 492/47; 29/402.01

(57) ABSTRACT

The invention relates to a method for repairing a printing roller having a roller base body made (10) of plastic or a plastic compound material. Into the two end regions (14) of the roller base body, bearing support members (16) are inserted, said bearing support members being connected to the roller base body (10) by bonding. Due to the occurrence of high stresses during the operation of the printing roller, inner surfaces (24) of the bearing support members (16) may be damaged. The damaged bearing support members (16) will be milled on their inner surfaces (24). Then, a respective sleeve (32,44) is inserted into the bearing support members (16). The inner surfaces (36) of the sleeves (32,44) serve for taking up outer bearing rings (26) of the roller bearings supporting the printing roller. The invention further relates to a printing roller with inserted sleeve (32,44).

### BACKGROUND OF THE INVENTION

1. Field of the Invention

The invention relates to a method for repairing a roller, and to a roller.

2. Description of the Prior Art

Rollers are rotationally symmetrical bodies which are used in a wide range of technical fields to exert pressure onto a material. They are used for the shaping of materials but are also widely used in printing machines for transfer of ink onto various bodies. The rollers used in printing machines are referred to as printing rollers.

Rollers comprise a cylindrical roller base body. In the two end sides of said roller base body, bearing support members are inserted. The bearing support members serve for taking up the outer bearing rings of roller bearings for support of the printing roller. The roller bearings are arranged on an axis or on support pins and on the bearing support members. The outer surface of the roller base body is provided with a coating or with covers, depending on the application of the printing roller. For use as covers, e.g. elastomers such as e.g. rubber or polyurethane are provided.

Due to the high mechanical stresses acting on the bearing support members which normally are made of metal, particularly steel, it is required to repair them at regular intervals. If the roller base bodies are made of metal, the repair work can be carried out on the bearing support members by performing a welding deposition onto the damaged regions of the bearing support members and then performing a surface treatment of the bearing support members by milling. Thereafter, new roller bearings can be inserted into the bearing support members.

For about 15 years, use has been made of printing rollers whose roller base body consists of a plastic material, particularly a plastic compound material. The latter will particularly be a carbon-fiber-reinforced or glass-fiber-reinforced material. The bearing support members, made particularly of metal such as e.g. steel, are bonded into the end regions of the cylindrical roller base bodies which are made of plastic or plastic compound materials. This has the consequence that the surfaces of damaged bearing support members cannot be repaired by welding deposition and subsequent milling because the welding operation would considerably heat up the bearing support member. This could result in partial detachment or damage of the bonding connection between the bearing support member and the roller base body. Further, the high temperatures introduced into the roller base body could cause a change of the structure of the roller base body. Since, for safety reasons, repairing of bearing support members by welding deposition is not possible in printing rollers comprising roller base bodies made of plastic and plastic compound materials, it is necessary to completely exchange the bearing support members. This will especially involve high costs. Further, complete removal of the bearing support member will entail the risk of damage to the roller base body because the bonding connection between the bearing support member and the roller base body has to be released.

It is an object of the invention to provide a method for repairing a roller having a roller base body made of plastic or plastic compound materials, which method shall be less expensive and/or avoid damage to the roller base body. Further, it is an object of the invention to provide a corresponding roller.

According to the invention, the above object is achieved by a method as defined in claim 1 and respectively by a roller as defined by claim 8.

### SUMMARY OF THE INVENTION

In the inventive method for repairing a roller having a roller base body made of plastic or plastic compound materials such as e.g. carbon-fiber- or glass-fiber-reinforced plastic, there is, in a first step, performed a machining process on the damaged bearing support members which are connected to the two end regions of the roller base body by bonding. Said machining of the inner surfaces of the bearing support members is performed particularly by milling. By machining the inner surfaces of the bearing support members, the damaged regions will be removed, thus restoring smooth inner surfaces of the bearing support members. Then, a respective sleeve will be inserted into each of the bearing support members. Thereafter, the outer bearing rings of the roller bearings supporting the printing roller can be inserted into said sleeves, so that the outer surfaces of the bearing rings will be in abutment on the inner surfaces of the sleeves. The outer rings of the roller bearings will e.g. be pressed into the sleeves. By the inventive machining of the bearing support members and the subsequent insertion of sleeves, it is, according to the invention, not required anymore to exchange damaged support members. Further, the inventive method obviates the need to repair the damaged inner surfaces of the bearing support members by welding deposition and subsequent milling. In this manner, a massive heating of the bearing support members, which would lead to damage of the bonding connection between the bearing support members and the roller base body, and/or to changes of the structure of the roller base body, will be avoided.

In order to ensure that the roller bearings supporting the printing roller are in coaxial alignment, it is provided, according to an especially preferred variant of the inventive method, that the inner sides of the sleeves will be treated. By a suitable treatment, preferably by grinding, honing or milling or by another machining process, coaxial inner sides of the sleeves will be produced. Thereby, it is safeguarded that also the roller bearings inserted in the sleeves are arranged coaxially.

Preferably, the sleeves are secured in the bearing support members so as to protect the sleeves from twisting or from sliding out axially. For instance, the sleeves can be bonded into the bearing support members. Further, it is possible to secure the sleeves in the bearing support members by means of welding spots. Such welding spots are provided on the outer common end sides of a bearing support member and of the inserted sleeve. In this region, it is possible to provide a fixation by welding because, on the one hand, the generating of welding spots will cause a lesser degree of heating of the bearing support members and, further, the welding spots have a relatively large distance to the region of the bonding connection between the bearing support members and the roller base body. A danger of damage to the bonding connection or of a change of the structure of the roller base body will thus not exist.

According to a particularly preferred embodiment, securement of the sleeves is performed by the provision of securement pins. These are preferably arranged on the common end side of the bearing support member and of the inserted sleeve. Preferably, for this purpose, there are provided substantially axial bores arranged partially within the sleeves and partially within the appertaining bearing support members. Thus, a center line of the bore preferably extends in the interface between the outer side of the sleeve and the inner face of the bearing support member. With particular preference, the securement pins are realized as threaded pins which are screwed into corresponding bores. However, it is also possible to press the securement pins into bores.

For renewed repair of a roller, the sleeve can be exchanged. This repair work can be done by performing a milling treatment on the sleeve, while it is preferred to remove the sleeve from the bearing support member. This, particularly, is possible in a an easier manner if the sleeve has been secured by securement pins, preferably threaded pins. After removal of the damaged sleeve, a machining process may be performed on the inner side of the bearing support member in case that also this member has been damaged. In this case, there is then inserted a new shell having a larger outer diameter than the first shell. Irrespective of whether the bearing support member will be machined again, insertion of the new sleeve will be performed corresponding to the insertion of a sleeve during the first repair work. Herein, it is preferred that the bores for the securement pins are arranged at a circumferential offset to the first bores, i.e. the old bores.

The invention further relates to a roller, preferably a repaired roller. This roller again comprises a roller base body made of plastic, particularly a plastic compound material such as e.g. carbon-fiber- or glass-fiber-reinforced plastic. In the two end regions of the roller base body, bearing support members are inserted which are connected to the roller base body by bonding. Inserted in the bearing support members are sleeves for receiving outer bearing rings of the roller bearings supporting the rollers. Said roller bearings serve for bearing support of the roller on an axis or a bearing pin.

A roller as described above, particularly a repaired roller of this type, has the advantages described in connection with the inventive method.

Preferably, the bearing support members for receiving the sleeves comprise an inner surface which is formed as a receiving region for the sleeves. In case of damaged bearing support members, said receiving region is generated, as described above in connection with the inventive method, by machining and preferably milling the bearing support members.

For safeguarding a coaxial support of the roller, the sleeves, according to a preferred embodiment, comprise coaxial sleeve inner surfaces for receiving the bearing outer rings of the roller bearings. Herein, said coaxial sleeve inner surfaces are preferably generated by machining such as e.g. grinding, honing or milling the sleeves after the sleeves have been inserted into the bearing support members.

For securing the sleeves in the bearing support members, the latter, according to a preferred embodiment, comprise bores on common end sides of the sleeve and the associated bearing support member, with securement pins being inserted into said bores. Preferably, said bores are again arranged and designed in the manner described in connection with the inventive method.

Optionally, the sleeves are provided with an inner bearing abutment. This abutment is preferably realized in the form of one or a plurality of radially inward projections, it being preferred that an annular projection is provided. In case that the bearing abutment provided in the original bearing support members is not damaged, also cylindrical sleeves can be inserted.

The inventive roller, particularly the repaired inventive roller, is preferably produced in the manner described in connection with the inventive method.

Preferably, the rollers of the invention are printing rollers, i.e. rollers for use in printing machines.

The invention will be described in greater detail hereunder with reference to the accompanying drawings.

### DETAILED DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

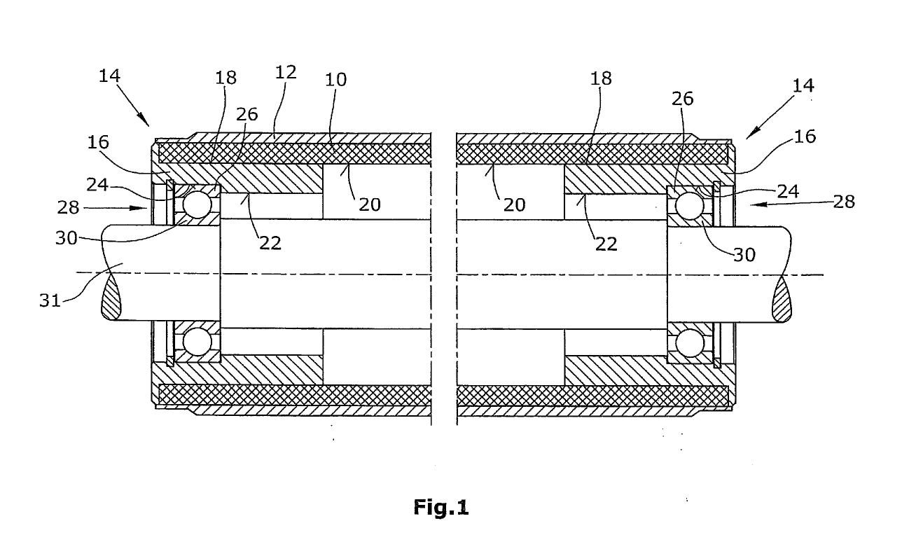

FIG. 1 is a schematic sectional view of a roller prior to being repaired,

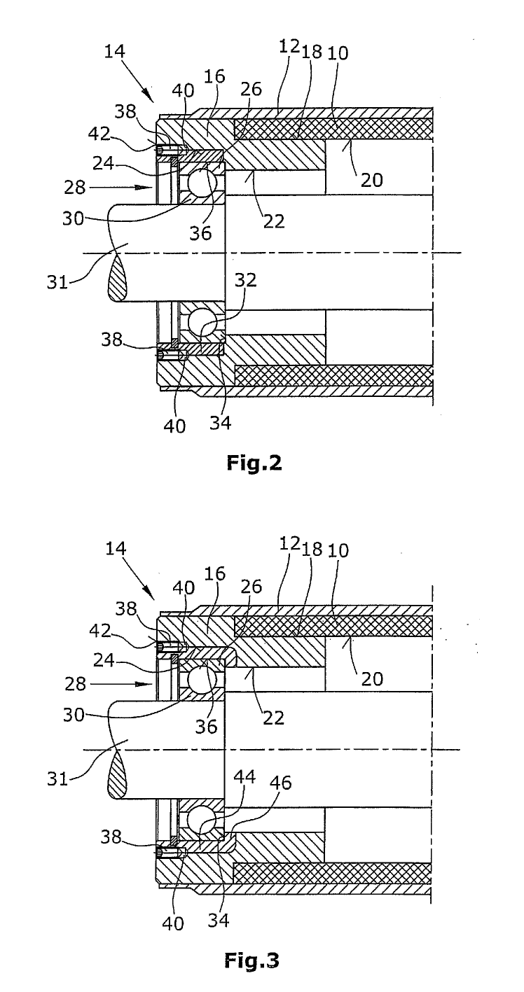

FIG. 2 is a schematic sectional view of a roller with inserted, substantially cylindrical sleeve, and

FIG. 3 is a schematic sectional view of a roller with inserted, substantially cylindrical sleeve, wherein the sleeve additionally comprises an inner bearing abutment.

### DETAILED DESCRIPTION OF PREFERRED EMBODIMENTS

A roller comprises a cylindrical roller base body made of plastic or a plastic compound material such as e.g. carbon-fiber-reinforced or glass-fiber-reinforced plastic. On an outer surface of the roller base body 10, a covering 12 is arranged. Depending on the respective application, said covering is made of rubber. Into each of the two end regions 14 of roller base body 10, a bearing support member 16 is inserted. Said bearing support member 16 is normally made of steel. An outer side 18 of bearing support member 16 is connected to an inner side 20 of roller base body 10 by bonding. Inner sides 22 of the bearing support members 16 have been ground so as to form an inner surface 24 abutted by an outer ring 26 of a roller bearing 28. The inner rings 30 of roller bearing 28 are arranged on an axis 31 carrying the printing roller.

Due to the wear caused to said covering 12, it is required exchange the covering at regular intervals. In doing so, the covering 12 is removed and replaced by a new covering, wherein this removal may also result in a reduction of the thickness of the roller base body 10. This will cause a weakening of the base body and then an increased warpage of the roller base body 10 in operation. Because of the high stresses acting on the roller bearings 28 during operation, which possibly are even intensified also under the effect of the increased warpage, it is required to exchange also the roller bearings 28 at regular intervals. The high stresses have the consequence that the inner surfaces 24 of the bearing support members 16 will be damaged.

According to the invention, the damaged inner surfaces 24 are repaired by machining, particularly by milling. Then, according to a first embodiment of the invention (FIG. 2), a substantially cylindrical shell 32 will be placed into a milled bearing support member 16. In the first embodiment of the invention produced in the manner provided by the invention, a substantially cylindrical sleeve 32 can be provided, under the precondition that an inner bearing abutment 34 of bearing support member 16 on which the outer bearing ring 26 of roller bearing 28 abuts, has not been damaged.

After insertion of the two substantially cylindrical bearing sleeves 32, the sleeve inner faces 36 are e.g. milled or ground so that the two sleeve inner faces 36 are coaxial with each other. Thereby, it is safeguarded that also the roller bearings 28 in the mounted condition are coaxial with each other.

For protecting the sleeves 32 against twisting or axial sliding, securement pins 38 are provided. According to the invention, for instance, respectively two pins 38 are provided which are displaced by 180° on the circumference of the bushes 32. For positioning the pins 38, bores 40 are provided. Said bores 40 are open in the direction of the common end sides 42 of the bearing support members 16 and of the sleeves 32. Particularly, the bores are provided with threads so that, for use as securement pins 38, threaded pins can be screwed into the bores. This has the advantage that, in case of renewed repair work, the sleeves 32 can be exchanged in a simple manner.

In case that also the inner bearing abutment 34 is damaged, sleeves 44 (FIG. 3) will be used. On their inward end, said sleeves 44 are provided with a radially inward, particularly annular projection 46. Projection 46 serves as a bearing abutment. Further, the sleeves 44 will be inserted corresponding to the sleeves 32 after corresponding preparation of the inner faces 24 of the bearing support members 16 and will again be fixed by pins 38.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A method for repairing a roller having a roller base body made of plastic or a plastic compound material, comprising the inserting of bearing support members into the two end regions of the roller base body, said bearing support members having been connected to the roller base body by bonding, wherein
damaged bearing support members are machined, particularly milled, on an inner surface thereof, and,
a respective sleeve is inserted into the bearing support members, the inner surface of said sleeves serving for taking up outer bearing rings of the roller bearings supporting the roller.

2. The method according to claim 1, wherein, after insertion of the bearing support members, the inner sides of the sleeves are treated to produce coaxial sleeve inner sides.

3. The method according to claim 1, wherein the sleeves are fixed in the bearing support members by securement pins, particularly threaded pins, which are inserted on end sides.

4. The method according to claim 3, wherein the securement pins are inserted into bores arranged partially in the sleeves and partially in the bearing support members.

5. The method according to claim 1, wherein, for renewed repair, the sleeves are exchanged.

6. The method according to claim 5, wherein, after removal of the damaged sleeves, the bearing support member is machined, particularly milled, and a new sleeve with a larger outer diameter is inserted.

7. The method according to claim 5, wherein new bores for securement pins are generated with circumferential displacement between old bores.

8. A roller, particularly a repaired roller, comprising
a roller base body made of plastic or a plastic compound material,
bearing support members inserted into the two end regions of the roller base body, said bearing support members being connected to the roller base body by bonding, and
sleeves inserted into the bearing support members for taking up outer bearing rings of the roller bearings supporting the roller.

9. The device according to claim 8, wherein the bearing support members for taking up the sleeves comprise an inner surface generated by machining, particularly milling.

10. The device according to claim 8, wherein the sleeves comprise coaxial sleeve inner surfaces for taking up the bearing outer rings.

11. The device according to claim 8, wherein the sleeves are provided with an inner bearing abutment preferably formed by a radial, inward projection.

12. The device according to claim 8, wherein, on a common end side of a respective sleeve and one of the bearing support members, at least one bore is provided for taking up a securement pin.

13. The device according to claim 12, wherein said at least one bore is arranged partially in the respective sleeve and partially in the respective bearing support member.

14. A repaired roller, particularly according to claim 8, produced by the method according to claim 1.

15. A roller according to claim 1, wherein the roller is a printing roller.
